(19) United States
(12) Patent Application Publication
(10) Pub. No.: US 2026/0221494 A1
(43) Pub. Date: Jul. 30, 2026

(54) Composite Solid Electrolyte Layer and Preparation Method thereof

(71) Applicant: Microvast, Inc., Stafford, TX (US)

(72) Inventors: Jinbo HE, Huzhou (CN); Weifeng FANG, Huzhou (CN); Heji HUANG, Huzhou (CN); Wenjuan Liu Mattis, Stafford, TX (US); Yang WU, Stafford, TX (US)

(73) Assignee: Microvast, Inc., Stafford, TX (US)

(21) Appl. No.: 19/038,043

(22) Filed: Jan. 27, 2025

(51) Int. Cl. H01M 10/0562

(52) U.S. Cl. CPC H01M 10/0562; H01M 2300/0085

(57) ABSTRACT

Provided are a composite solid electrolyte layer and a preparation method thereof. The preparation method includes: step S1, coating a solid electrolyte raw material on two side surfaces of an aramid base film, so as to obtain a composite solid electrolyte layer precursor; step S2, covering a release film on at least one side surface of the composite solid electrolyte layer precursor, so as to obtain a first laminated structure; and step S3, performing a first hot rolling treatment on the first laminated structure, and then peeling off the release film to obtain a composite solid electrolyte layer. In the present disclosure, the solvent-free solid electrolyte raw material is used for coating, such that the problem of solvent residues is solved. The introduction of the aramid base film can provide a skeleton for the preparation of the composite solid electrolyte layer precursor. The introduction of the release film can serve to protect the composite solid electrolyte layer precursor. The composite solid electrolyte layer prepared by using the preparation method has excellent flexibility and mechanical strength and high ionic conductivity.

### FIELD

The present disclosure relates to the technical field of solid electrolytes, and specifically, to a composite solid electrolyte layer and a preparation method thereof.

### BACKGROUND

A solid battery generally includes a positive electrode, a negative electrode, and an electrolyte, and the electrolyte is a solid electrolyte material. The solid battery has received a great deal of attention in the field of global energy research because of its high energy density, good safety performance, etc.

As a core component of the solid battery, the solid electrolyte can realize the transport of lithium ions between the positive and negative electrodes, and may also be used as a separator to separate the positive and negative electrodes, so as to prevent internal short circuits, thereby ensuring the safe operation of the battery. At present, the developed solid electrolyte is mainly classified into three types, which are an inorganic solid electrolyte, a polymer solid electrolyte, and a composite solid electrolyte. The inorganic solid electrolyte becomes the main choice for manufacturing high-performance solid batteries due to its high ionic conductivity and thermal stability.

### SUMMARY

Conventional inorganic solid electrolytes have certain brittleness problems. In a production process, the brittle nature of the solid electrolyte makes it difficult to process a material into a film, limiting its flexibility in battery design and scale production. Meanwhile, during the use of the battery, the brittleness of the inorganic solid electrolyte makes it susceptible to generate microcracks under mechanical stress. These microcracks reduce the conductivity of the electrolyte, and provide channels for the growth of lithium dendrites, easily leading to internal short circuits of the battery, thus posing a threat to the safety and service life of the battery.

Based on this, a composite solid electrolyte layer and a preparation method thereof are studied and developed, which have great significance to improve processability, flexibility, mechanical strength, and ionic conductivity, thereby improving the safety, cycling stability, and service life of solid batteries.

The present disclosure is mainly intended to provide a composite solid electrolyte layer and a preparation method thereof, so as to solve the problems in the related art of an inorganic solid electrolyte difficult to be processed into a film, and poor flexibility and mechanical strength and low ionic conductivity of an inorganic solid electrolyte layer, as well as poor safety and cycling stability and short service life of a solid battery prepared by the inorganic solid electrolyte.

In order to implement the above objectives, an aspect of the present disclosure provides a method for preparing a composite solid electrolyte layer. The method including: step S1, coating a solid electrolyte raw material on two side surfaces of an aramid base film, so as to obtain a composite solid electrolyte layer precursor; step S2, covering a release film on at least one side surface of the composite solid electrolyte layer precursor, so as to obtain a first laminated structure; and step S3, performing a first hot rolling treatment on the first laminated structure, and then peeling off the release film to obtain the composite solid electrolyte layer.

As an implementation, the solid electrolyte raw material does not contain a liquid, or the solid electrolyte raw material does not contain a solvent.

As an implementation, the step S1 further comprising: performing a melting treatment on the solid electrolyte raw material to obtain a solid electrolyte melt, and coating the solid electrolyte melt on the two side surfaces of the aramid base film, so as to obtain the composite solid electrolyte layer precursor.

As an implementation, the solid electrolyte raw material includes a solid electrolyte powder and an adhesive. The step S1 further comprising: performing a melting treatment on the solid electrolyte raw material to obtain a solid electrolyte melt, and coating the solid electrolyte melt on the two side surfaces of the aramid base film, so as to obtain the composite solid electrolyte layer precursor.

As an implementation, a weight ratio of the solid electrolyte powder to the adhesive is (95-99): (1-5).

As an implementation, a coating amount of the solid electrolyte melt on the surface of the aramid base film is 20 g/m² to 60 g/m².

As an implementation, a temperature for the melting treatment is 80° C. to 250° C., or the temperature for the melting treatment is 100° C. to 250° C., and a time is 1 min to 30 min.

As an implementation, an average particle size of the solid electrolyte powder is 0.1 μm to 10 μm.

As an implementation, the solid electrolyte powder is an inorganic solid electrolyte powder. The inorganic solid electrolyte powder is selected from one or more of a group consisting of an oxide solid electrolyte, a sulfide solid electrolyte, and a halide solid electrolyte. The oxide solid electrolyte is selected from one or more of a group consisting of a perovskite solid electrolyte, a lithium phosphorus oxynitride solid electrolyte, a NASICON-type solid electrolyte, and a garnet-type solid electrolyte. The sulfide solid electrolyte is selected from an argyrodite solid electrolyte and/or Li₂S-P₂S₅. The halide solid electrolyte is selected from Li₃YCl₆ and/or Li₃BrCl₆.

As an implementation, the adhesive is selected from one or more of a group consisting of polyvinylidene fluoride, poly vinylidene fluoride-hexafluoropropylene copolymer, polyacrylate, poly acrylic acid-acrylate copolymer, polyvinyl ester, polyethylene ester hydrolysis derivative, polyacrylonitrile, poly acrylonitrile-vinyl acetate copolymer, thermoplastic polyamide, styrene butadiene rubber, hydrogenated derivative of the styrene butadiene rubber, carboxymethyl cellulose, and carboxymethyl cellulose hydroxy-substituted derivative.

As an implementation, the release film is a solid film without pores. A thickness of the release film is 10 μm to 50 μm. A material of the release film is a first organic polymer material, and the first organic polymer material is selected from one or more of a group consisting of polyimide, polyethylene terephthalate, polyether ether ketone, poly(p-phenylene sulfide), and poly(p-phenylene benzobisoxazole).

As an implementation, the aramid base film is a porous film. The porosity of the aramid base film is 50% to 90%, or the porosity of the aramid base film is 50% to 70%, or the porosity of the aramid base film is 60% to 65%. An average pore diameter of the aramid base film is 0.1 μm to 2000 μm. A thickness of the aramid base film is 3 μm to 25 μm.

As an implementation, a thickness of the composite solid electrolyte layer precursor is 5 μm to 50 μm.

As an implementation, the preparation method further including: when a temperature of the composite solid electrolyte layer precursor is 50° C. to 250° C., covering the release film on at least one side surface of the composite solid electrolyte layer precursor, so as to obtain the first laminated structure.

As an implementation, in the step S3, a temperature for the first hot rolling treatment is 50° C. to 250° C., or 130° C. to 200° C.; or a pressure of the first hot rolling treatment is 0.5 MPa to 50 MPa; or a time for the first hot rolling treatment is 1 min to 30 min.

Another aspect of the present disclosure further provides a composite solid electrolyte layer. The composite solid electrolyte layer is prepared by the method for preparing a composite solid electrolyte layer provided in the present disclosure.

By using the technical solutions of the present disclosure, in order to improve the brittle characteristics of an existing inorganic solid electrolyte layer itself and solve the problem of an inorganic solid electrolyte to be processed into a film during production, the present disclosure provides a method for preparing a composite solid electrolyte layer. Compared with the preparation of a solid electrolyte layer using a solution casting method or a solution coating method in the prior art, in the present disclosure, the release film is covered on the surface of the composite solid electrolyte layer precursor, and then the first hot rolling treatment is performed. By introducing the release film, a direct contact between the composite solid electrolyte layer precursor and a hot-pressing roller in a first hot rolling process can be inhibited, such that the adhesion of the composite solid electrolyte layer precursor and the occurrence of pollution phenomena are reduced, thereby improving the processing performance. Meanwhile, the purity and structural integrity of the composite solid electrolyte layer prepared can be improved, the generation of cracks during use is inhibited to prevent internal short circuits of a solid battery prepared, thereby improving the cycling stability and use safety of the solid battery. Furthermore, compared with other types of base films, the aramid base film has excellent flexibility, thermal stability, and mechanical properties, and can provide a support skeleton for the preparation of the composite solid electrolyte layer precursor, such that the prepared composite solid electrolyte layer can have excellent flexibility, mechanical strength, and good ionic conductivity.

### BRIEF DESCRIPTION OF DRAWINGS

The drawings, which form a part of the present disclosure, are used to provide a further understanding of the present disclosure. The exemplary embodiments of the present disclosure and the description thereof are used to explain the present disclosure, but do not constitute improper limitations to the present disclosure. In the drawings:

FIG. 1 is a Scanning Electron Microscope (SEM) diagram of a surface of a composite solid electrolyte layer prepared according to Embodiment 1 of the present disclosure.

FIG. 2 is an Electrochemical Impedance Spectroscopy (EIS) diagram of a composite solid electrolyte layer prepared according to Embodiment 1 of the present disclosure.

### DESCRIPTION OF EMBODIMENTS

It is to be noted that the embodiments in the present disclosure and the features in the embodiments may be combined with one another without conflict. The present disclosure will be described below in detail with reference to the embodiments.

As described in Background, there are problems of an inorganic solid electrolyte, such as difficult to be processed into a film, and poor flexibility and mechanical strength and low ionic conductivity of an inorganic solid electrolyte layer, as well as poor safety and cycling stability and short service life of a solid battery prepared (e.g., an all-solid lithium ion battery) by the inorganic solid electrolyte. In order to solve the above technical problems, an aspect of the present disclosure provides a method for preparing a composite solid electrolyte layer. The method including: step S1, coating a solid electrolyte raw material on two side surfaces of an aramid base film, so as to obtain a composite solid electrolyte layer precursor; step S2, covering a release film on at least one side surface of the composite solid electrolyte layer precursor, so as to obtain a first laminated structure; and step S3, performing a first hot rolling treatment on the first laminated structure, and then peeling off the release film to obtain the composite solid electrolyte layer.

It is to be noted that, a material of the aramid base film in the present disclosure is poly(phenylene terephthalamide).

Compared with other types of base films, the aramid base film has excellent flexibility, thermal stability, and mechanical properties, and can provide a support skeleton for the preparation of the composite solid electrolyte layer precursor, such that the prepared composite solid electrolyte layer can have excellent flexibility, mechanical strength, and good ionic conductivity. In the step S2, the release film is covered on the surface of the composite solid electrolyte layer precursor, and then the first hot rolling treatment in the step S3 is performed. The first hot rolling treatment can increase a compaction density of the composite solid electrolyte layer, thereby improving interface stability. By introducing the release film, a direct contact between the composite solid electrolyte layer precursor and a hot-pressing roller in a first hot rolling process can be inhibited, such that the adhesion of the composite solid electrolyte layer precursor and the occurrence of pollution phenomena are reduced, thereby improving the processing performance. Meanwhile, the purity and structural integrity of the composite solid electrolyte layer prepared can be improved, the generation of cracks during use is inhibited to prevent internal short circuits of a solid battery prepared, thereby improving the cycling stability and use safety of the solid battery.

As an implementation, the step S1 further including: performing a melting treatment on the solid electrolyte raw material to obtain a solid electrolyte melt, and coating the solid electrolyte melt on the two side surfaces of the aramid base film, so as to obtain the composite solid electrolyte layer precursor. Compared with other methods, the solvent-free composite solid electrolyte layer precursor is obtained by using the method, inhibiting side reactions between a solid electrolyte and a solvent, and the occurrence of micro-pores formed due to solvent volatilization and uneven distribution, as well as solvent residues, thereby improving the uniformity and compactness of the composite solid electrolyte layer precursor prepared, and improving an interactive force between the solid electrolyte melt and the aramid base film. Consequently, it can improve the ionic conductivity, mechanical strength, and structure stability of the composite solid electrolyte layer, and thereby enhance the cycling stability and use safety, prolonging the service life of the solid battery.

In order to further inhibit the side reactions between the solid electrolyte and the solvent, inhibit the occurrence of the micro-pores formed due to solvent volatilization and uneven distribution, reduce the solvent residues, improve the uniformity and compactness of the composite solid electrolyte layer precursor prepared, and improve the ionic conductivity, mechanical strength, and structure stability of the composite solid electrolyte layer, and also in order to reduce production costs and reduce environmental pollution, as an implementation, the solid electrolyte raw material does not contain a liquid, or the solid electrolyte raw material does not contain a solvent.

As an implementation, the solid electrolyte raw material includes a solid electrolyte powder and an adhesive. The step S1 further including: performing a melting treatment on the solid electrolyte raw material to obtain a solid electrolyte melt, and coating the solid electrolyte melt on the two side surfaces of the aramid base film, so as to obtain the composite solid electrolyte layer precursor. Compared with other methods, the solid electrolyte powder and the adhesive are directly mixed and melted to obtain the solid electrolyte melt, so as to obtain the solvent-free solid electrolyte melt, thereby inhibiting side reactions between the solid electrolyte powder and the solvent, and the occurrence of micro-pores formed due to solvent volatilization and uneven distribution. Moreover, it can improve the uniformity and compactness of the composite solid electrolyte layer precursor prepared, and the interactive force between the solid electrolyte melt and the aramid base film, thereby enhancing the ionic conductivity, mechanical strength, and structure stability of the composite solid electrolyte layer.

In order to obtain the composite solid electrolyte layer precursor with more appropriate thickness, improve the utilization of the solid electrolyte melt, and also in order to further enhance the ionic conductivity of the composite solid electrolyte layer, as an implementation, a coating amount of the solid electrolyte melt on the surface of the aramid base film is 20 g/m² to 60 g/m², or 30 g/m² to 45 g/m².

As an implementation, a temperature for the melting treatment is 80° C. to 250° C., or 100° C. to 250° C., and a time is 1 min to 30 min; or the temperature is 120° C. to 200° C., and the time is 5 min to 20 min; or the temperature 130° C. to 150° C., and the time is 10 min to 15 min. The temperature and time for the melting treatment include, but are not limited to, the above ranges. By limiting the temperature and time within the above ranges, the dispersity of the solid electrolyte powder and the adhesive is improved, and decomposition side reactions of the adhesive are inhibited. Moreover, the adhesive plays a better role in achieving an adhesion action, thereby improving the uniformity of the solid electrolyte melt, and improving the uniformity and compactness of the composite solid electrolyte layer precursor.

As an implementation, an average particle size of the solid electrolyte powder is 0.1 μm to 10 μm, 1 μm to 10 μm, or 2 μm to 5 μm. The average particle size of the solid electrolyte powder includes, but is not limited to, the above range. By limiting the average particle size within the above range, the processability of the solid electrolyte powder is improved, a compaction density of the composite solid electrolyte layer is increased, and the amount of the adhesive used is reduced, thereby improving the utilization of the solid electrolyte raw material, and reducing production costs.

As an implementation, a weight ratio of the solid electrolyte powder to the adhesive is (95-99): (1-5), or (97-99): (1-3). The weight ratio of the solid electrolyte powder to the adhesive includes, but is not limited to, the above range. By limiting the weight ratio within the above range, the processability of the solid electrolyte powder is improved, the utilization of the solid electrolyte powder and the adhesive is improved, and a volume and interface of the composite solid electrolyte layer occupied by excessive adhesive are reduced, thereby enhancing the mechanical strength and ionic conductivity of the composite solid electrolyte layer, and further improving the utilization of the solid electrolyte powder and the adhesive.

As an implementation, the solid electrolyte powder is an inorganic solid electrolyte powder. As another implementation, the inorganic solid electrolyte powder includes, but is not limited to, one or more of a group consisting of an oxide solid electrolyte, a sulfide solid electrolyte, and a halide solid electrolyte. Specifically, the oxide solid electrolyte includes, but is not limited to, one or more of a group consisting of a perovskite solid electrolyte, a lithium phosphorus oxynitride solid electrolyte, a NASICON-type solid electrolyte, and a Garnet-type solid electrolyte. The sulfide solid electrolyte includes, but is not limited to, an argyrodite solid electrolyte and/or a Li₂S—P₂S₅ solid electrolyte. The halide solid electrolyte is selected from lithium yttrium hexachloride (Li₃YCl₆) and/or lithium bromide hexachloride (Li₃BrCl₆).

Compared with other types, the solid electrolyte powder of the above type has higher ionic conductivity and chemical stability, improving the ionic conductivity and structure stability of the composite solid electrolyte layer, thereby improving the cycling stability and use safety of the solid battery, and prolonging the service life of the solid battery.

In order to improve the adhesion performance and thermal stability of the adhesive, thereby further improving the processability of the composite solid electrolyte layer precursor and further improving the uniformity, compactness, and structure stability of the electrolyte layer, as an implementation, the adhesive includes, but is not limited to, one or more of a group consisting of polyvinylidene fluoride (PVDF), poly vinylidene fluoride-hexafluoropropylene copolymer (PVDF-HFP), polyacrylate (PAA), poly acrylic acid-acrylate copolymer, polyvinyl ester (PET), a polyethylene ester hydrolysis derivative, polyacrylonitrile (PAN), poly acrylonitrile-vinyl acetate copolymer, thermoplastic polyamide, styrene butadiene rubber (SBR), a hydrogenated derivative of the styrene butadiene rubber, carboxymethyl cellulose (CMC), and a carboxymethyl cellulose hydroxy-substituted derivative.

As in implementation, the release film is a solid film without pores. Compared with a porous film, by using the solid film without pores as the release film, a direct contact between the composite solid electrolyte layer precursor and a hot-pressing roller is inhibited, and damages and pollution caused by adhesion between the composite solid electrolyte layer precursor and the hot-pressing roller are inhibited, improving the processability of the composite solid electrolyte layer precursor and the purity and structural integrity of the composite solid electrolyte layer, thereby improving the cycling stability and use safety of the solid battery.

In order to better achieve the action of the release film to protect the composite solid electrolyte layer precursor, so as to further inhibit the damages and pollution caused by adhesion between the composite solid electrolyte layer precursor and the hot-pressing roller, and also in order to realize easy peeling after the first hot rolling treatment, so as to obtain the composite solid electrolyte layer, as an implementation, a thickness of the release film is 10 μm to 50 μm.

As an implementation, a material of the release film is a first organic polymer material. Specifically, the first organic polymer material includes, but is not limited to, one or more of a group consisting of polyimide (PI), polyethylene terephthalate (PET), polyether ether ketone (PEEK), poly(p-phenylene sulfide) (PPS), and poly(p-phenylene benzobisoxazole) (PBO). Compared with other types, the first organic polymer material of the above type has excellent thermal stability and chemical stability. By using the first organic polymer material as the material of the release film, the function of the release film is better achieved, preventing the composite solid electrolyte layer precursor from being damaged and polluted during the hot rolling treatment, thereby improving the purity and structural integrity of the composite solid electrolyte layer prepared.

As an implementation, the aramid base film is a porous film. A porous structure of the aramid base film provides more filling space for the electrolyte material, so as to improve the flexibility of the composite solid electrolyte layer while the mechanical strength thereof is improved. Moreover, it also provides more channels for the transport of lithium ions, so as to improve the ionic conductivity of the composite solid electrolyte layer, thereby improving the cycling stability and use safety of the solid battery.

In order to further fill the solid electrolyte material to be more fully in pores of the aramid base film, and further provide more channels for the transport of the lithium ions, thereby improving the flexibility, mechanical strength, and ionic conductivity of the composite solid electrolyte layer and improving the cycling stability and use safety of the solid battery, and also in order to inhibit a reduction in the mechanical strength due to excessive filling of the solid electrolyte material, as an implementation, the porosity of the aramid base film is 50% to 90%, or 50% to 70%.

In order to further providing a more appropriate space for the filling of the solid electrolyte material and the transport of the lithium ions, and also in order to further inhibit the reduction in the mechanical strength due to excessive filling of the solid electrolyte material, as an implementation, the porosity of the aramid base film is 60% to 65%.

In order to further providing a more appropriate space for the filling of the solid electrolyte material and the transport of the lithium ions, and also in order to inhibit leakage during coating due to an excessively large average pore diameter, as an implementation, an average pore diameter of the aramid base film is 0.1 μm to 2000 μm, or 10 μm to 1800 μm, or 50 μm to 1300 μm, or 100 μm to 1000 μm, or 200 μm to 600 μm.

As an implementation, a thickness of the aramid base film is 3 μm to 25 μm, or 8 μm to 20 μm, or 10 μm to 15 μm. The thickness of the aramid base film includes, but is not limited to, the above range. By limiting the thickness within the above range, the aramid base film has excellent mechanical strength and flexibility, a support skeleton with a more appropriate thickness is provided for the preparation of the composite solid electrolyte layer precursor, thereby improving the mechanical strength, flexibility, and ionic conductivity of the composite solid electrolyte layer, and increasing an energy density of the solid battery. Furthermore, the aramid base film with the above thickness is also conductive to maintaining the amount of the solid electrolyte used within an appropriate range, thereby facilitating the reduction of costs.

As an implementation, a thickness of the composite solid electrolyte layer precursor is 5 μm to 50 μm, or 10 μm to 40 μm, or 15 μm to 30 μm, or 20 μm to 30 μm. The thickness of the composite solid electrolyte layer precursor includes, but is not limited to, the above range. By limiting the thickness within the above range, the ionic conductivity of the composite solid electrolyte layer is improved, improving the cycling stability and energy density of the solid battery, and the composite solid electrolyte layer has excellent mechanical strength while the flexibility thereof is improved, thereby inhibiting the internal short circuits of a battery caused by microcracks during use, facilitating the improvement of the use safety and cycling stability of the solid battery.

As an implementation, the preparation method provided in the present disclosure further including: when a temperature of the composite solid electrolyte layer precursor is 50° C. to 250° C., covering the release film on at least one side surface of the composite solid electrolyte layer precursor, so as to obtain the first laminated structure. Compared with other methods, by using the method, an adhesion force between the release film and the composite solid electrolyte layer precursor is increased, such that the release film plays a role in protecting the composite solid electrolyte layer precursor during the subsequent first hot rolling treatment, thereby improving the purity and structural integrity of the composite solid electrolyte layer.

As an implementation, a method for preparing the aramid base film includes: an aromatic diamine of C₆ to C₁₂ and an aromatic diacyl chloride of C₆ to C₁₂ undergo a polymerization reaction in a solvent to obtain an aramid slurry, and the aramid slurry is used to prepare the aramid base film.

The aromatic diamine is an aromatic compound containing two amino groups, and its nitrogen atom is directly connected to a carbon atom on an aromatic ring. The aromatic diacyl chloride is an aromatic compound containing two acyl chloride groups, and its acyl chloride groups are directly connected to the carbon atom on the aromatic ring. By causing the aromatic diamine and the aromatic diacyl chloride to undergo the polymerization reaction in the solvent, the aramid slurry can be obtained, and then the aramid base film of the present disclosure is prepared by using the aramid slurry. Compared with other methods, by using the preparation method, the aramid base film with excellent flexibility, thermal stability, and mechanical properties is obtained, thereby a support skeleton with a more stable structure and more excellent performance is provided for the preparation of the composite solid electrolyte layer precursor.

As an implementation, the method for preparing the aramid base film includes: the aromatic diamine of C₆ to C₁₂ and the aromatic diacyl chloride of C₆ to C₁₂ undergo the polymerization reaction in the solvent to obtain a polymerization reaction system; a neutralization treatment is performed on the polymerization reaction system to cause the pH of the polymerization reaction system to be 5 to 7, so as to obtain a neutralization product system; and the neutralization product system is coated on a surface of one side of a substrate, and is peeled off from the substrate after being cured, so as to obtain the aramid base film.

The polymerization reaction system can be obtained by causing the aromatic diamine of C₆ to C₁₂ and the aromatic diacyl chloride of C₆ to C₁₂ to undergo the polymerization reaction in the solvent, and the neutralization product system is obtained by adjusting the pH of the polymerization reaction system within an appropriate range through the neutralization treatment. In an aspect, it is beneficial for neutralizing an acidic substance (e.g., hydrogen chloride) generated in the polymerization reaction, and inhibiting degradation of a polymerization reaction product under an acidic condition. In another aspect, it is beneficial for improving the processability of subsequent processes. The neutralization product system is coated on the substrate and then peeled off after being cured, to obtain the aramid base film. It is beneficial for obtaining a uniformly-distributed aramid base film with high mechanical strength.

Compared with other methods, by using the method to prepare the aramid base film, a pore structure of the aramid base film is improved, and the chemical stability and mechanical properties (e.g., flexibility and mechanical strength) of the aramid base film are improved, thereby enhancing the flexibility, mechanical strength, and ionic conductivity of the composite solid electrolyte layer, improving the cycling stability and use safety of the solid battery, and prolonging the service life of the solid battery.

As an implementation, the method for preparing the aramid base film further including: mixing the neutralization product system with a salt and/or a second organic polymer material to obtain the aramid slurry; and coating the aramid slurry on the surface of one side of the substrate, and peeling off from the substrate after curing, so as to obtain the aramid base film. Compared with other methods, by introducing the salt and/or the second organic polymer material, the pore structure of the aramid base film is improved, and the porosity and pore diameter of the aramid base film are adjusted within appropriate ranges, thereby providing more spaces for the filling of the electrolyte material and the transport of the lithium ions. The prepared aramid slurry is coated on the substrate and peeled off after being cured, so as to obtain the aramid base film, thereby obtaining a uniformly-distributed aramid base film with high mechanical strength.

As an implementation, a temperature for the polymerization reaction is 0° C. to 10° C., and a time is 1 h to 8 h. The temperature and time for the polymerization reaction include, but are not limited to, the above ranges. By limiting the temperature and time within the above ranges, side reactions are inhibited, and the reaction efficiency of the polymerization reaction is improved, thereby improving the purity and yield of an aramid product in the polymerization reaction system.

As an implementation, a molar ratio of the aromatic diamine to the aromatic diacyl chloride is 1: (0.99-1.01). Compared with other ranges, by limiting the molar ratio of the aromatic diamine to the aromatic diacyl chloride within the above range, the reaction efficiency of the polymerization reaction is improved, the side reactions are inhibited, thereby the increasing the yield of the aramid product in the polymerization reaction system, and the utilization of the aromatic diamine and the aromatic diacyl chloride is improved, thereby reducing production costs.

In order to obtain different structures of the aramid base films to further improve the flexibility, thermal stability, and mechanical properties of the aramid base films, so as to subsequently prepare a composite solid electrolyte layer with more excellent performance, as an implementation, the aromatic diamine includes, but is not limited to, one or more of a group consisting of m-phenylenediamine, p-phenylenediamine, and 4,4′-diaminodiphenyl ether; and the aromatic diacyl chloride includes, but is not limited to, one or more of a group consisting of isophthaloyl dichloride, terephthaloyl chloride, and trimesoyl chloride.

As an implementation, a ratio of a weight of the solvent to a sum of weights of the aromatic diamine and the aromatic diacyl chloride is (70-90): (5-20). The ratio of the weight of the solvent to the sum of the weights of the aromatic diamine and the aromatic diacyl chloride includes, but is not limited to, the above range. By limiting the ratio within the above range, the dispersity of the aromatic diamine and the aromatic diacyl chloride is improved, thereby improving the reaction efficiency of the polymerization reaction.

In order to further improve the dispersity of the solid electrolyte raw material, thereby further improving the reaction efficiency of the polymerization reaction, as an implementation, the solvent includes, but is not limited to, one or more of a group consisting of N,N-dimethylacetamide (DMAC), N-methylpyrrolidone (NMP), N,N-dimethylformamide (DMF), and dimethyl sulfoxide (DMSO).

In order to neutralize the acidic substance (e.g., hydrogen chloride) generated in the polymerization reaction, thereby inhibiting the degradation of the polymerization product (aramid fiber) under the acidic condition, as an implementation, an alkali is used to perform the neutralization treatment on the polymerization reaction system.

In order to improve the efficiency of the neutralization treatment, adjust the pH of the neutralization product system to a more appropriate range, and further inhibit the degradation of the polymerization product under the acidic condition, as an implementation, a molar ratio of the alkali to the aromatic diacyl chloride is (0.5-1): 1.

In order to further improve the efficiency of the neutralization treatment, and further adjust the pH of the neutralization product system to a more appropriate range, as an implementation, the alkali includes, but is not limited to, one or more of a group consisting of calcium hydroxide, lithium hydroxide, calcium carbonate, lithium carbonate, and calcium bicarbonate.

As an implementation, in the aramid slurry, a weight percentage of the salt is 3 wt % to 10 wt %, and a weight percentage of the second organic polymer material is 5 wt % to 20 wt %. The weight percentages of the salt and second organic polymer material include, but are not limited to, the above ranges. By limiting the weight percentages within the above ranges, the pore structure of the aramid base film is improved, and the porosity and pore diameter of the aramid base film are adjusted within more appropriate ranges, thereby providing more spaces for the filling of the electrolyte material and the transport of the lithium ions, further improving the ionic conductivity of the composite solid electrolyte layer.

In order to further improve the pore structure of the aramid base film, further adjusting and controlling the porosity and pore diameter of the aramid base film within more appropriate ranges, thereby further improving the ionic conductivity of the composite solid electrolyte layer, as an implementation, the salt includes, but is not limited to one or more of a group consisting of lithium chloride, lithium fluoride, calcium chloride, carbonate, bicarbonate, and lithium bis(trifluoromethanesulphonyl)imide (LITFSI).

The carbonate and the bicarbonate can undergo a neutralization reaction with part of acidic substances remaining in a neutralization reaction system to produce carbon dioxide, so as to generate bubbles, thereby forming pore sizes ranging from micrometer to millimeter in situ. In order to further improve the pore structure of the aramid base film, as an implementation, the carbonate includes, but is not limited to, one or more of a group consisting of lithium carbonate and/or calcium carbonate; and the bicarbonate includes, but is not limited to, one or more of a group consisting of calcium bicarbonate and/or potassium bicarbonate.

In order to further improve the pore structure of the aramid base film, further providing more spaces for the filling of the electrolyte material and the transport of the lithium ions, thereby further improving the ionic conductivity of the composite solid electrolyte layer, as an implementation, the second organic polymer material includes, but is not limited to, one or more of a group consisting of polyethylene oxide (PEO), polyethylene glycol (PEG), polyvinyl pyrrolidone (PVP), polyacrylic acid (PAA), and polyvinyl alcohol (PVA).

In order to obtain the aramid base film with the more appropriate thickness, pore diameter, and porosity, as an implementation, a coating amount of the aramid slurry on the surface of the substrate is 10 g/m² to 80 g/m², or 20 g/m² to 70 g/m², or 30 g/m² to 60 g/m², or 40 g/m² to 50 g/m².

As an implementation, the aramid slurry may be cured by using a coagulating bath or be heat set at 100° C. to 250° C. Compared with other methods, by using the above method, the efficiency of curing and heat setting is improved, and the aramid base film with more uniform pore distribution is obtained.

As an implementation, the surface of the substrate is a smooth surface or a surface with protrusions. Compared with other types of substrates, by using the substrate in the above type, the pore structure of the aramid base film is improved, and an aramid base film with more uniform pore distribution is obtained.

As an implementation, in the step S3, a temperature for the first hot rolling treatment is 50° C. to 250° C., or 70° C. to 200° C., or 100° C. to 180° C., or 120° C. to 150° C. The temperature for the first hot rolling treatment includes, but is not limited to, the above range. By limiting the temperature within the above range, the efficiency of the first hot rolling treatment is improved, and the solid electrolyte material is softened, thereby increasing an interfacial binding force between layers in the first laminated structure, improving the ionic conductivity and structure stability of the composite solid electrolyte layer, as well as reducing the pressure and time of the first hot rolling treatment.

In order to further improve the efficiency of the first hot rolling treatment, further soften the solid electrolyte material, thereby further improving the interfacial binding force between the layers in the first laminated structure, and also in order to further reduce the pressure and time of the first hot rolling treatment, as an implementation, the temperature for the first hot rolling treatment is 130° C. to 140° C.

As an implementation, the pressure of the first hot rolling treatment is 0.5 MPa to 50 MPa, MPa to 40 MPa, or 10 MPa to 30 MPa, or 15 MPa to 25 MPa. The pressure of the first hot rolling treatment includes, but is not limited to the above range. By limiting the pressure within the above range, the efficiency of the first hot rolling treatment is improved, a compaction density of the composite solid electrolyte layer is increased, and interfacial impedance thereof is reduced, thereby improving the ionic conductivity of the composite solid electrolyte layer, and inhibiting damages to the aramid base film due to excessive pressure.

As an implementation, the time for the first hot rolling treatment is 1 min to 30 min, or 5 min to 30 min, or 10 min to 25 min, or 10 min to 15 min. The time for the first hot rolling treatment includes, but is not limited to the above range. By limiting the time within the above range, the compaction density of the composite solid electrolyte layer is increased, the interfacial impedance thereof is reduced, the ionic conductivity thereof is improved, and damages to the aramid base film due to excessively-long hot rolling treatment are inhibited.

A second aspect of the present disclosure further provides a composite solid electrolyte layer. The composite solid electrolyte layer is prepared by the method for preparing a composite solid electrolyte layer provided in the present disclosure.

It is to be noted that, due to the specificity of the field of solid electrolytes and the limitation of existing test characterization means, a complex microstructure of the prepared composite solid electrolyte layer are difficult to be subjected to full comprehensive quantitative characterization, but experiments show that, the composite solid electrolyte layer provided in the present disclosure has better processability, flexibility, mechanical strength, and ionic conductivity compared with conventional inorganic solid electrolyte layers. In the present disclosure, solvents are not introduced during the process of preparing the composite solid electrolyte layer. In an aspect, the side reactions between the solid electrolyte and the solvent can be inhibited; and in another aspect, the occurrence of micro-pores formed due to solvent volatilization and uneven distribution can be inhibited, thereby improving the ionic conductivity and mechanical strength of the composite solid electrolyte layer. Furthermore, compared with other types of base films, the aramid base film has more excellent flexibility, thermal stability, and mechanical properties, and by introducing the aramid base film into the composite solid electrolyte layer, a support skeleton can be provided for the preparation of the composite solid electrolyte layer precursor, thereby providing a composite solid electrolyte layer with excellent flexibility, mechanical strength, and good ionic conductivity. By introducing the release film, the direct contact between the composite solid electrolyte layer precursor and the hot-pressing roller in the hot rolling process can be inhibited, thereby reducing the adhesion of the composite solid electrolyte layer precursor and the occurrence of pollution phenomena, and improving the processing performance, and further improving the purity and structural integrity of the composite solid electrolyte layer, and inhibiting the generation of microcracks during use, preventing internal short circuits of the solid battery prepared, thereby improving the cycling stability and use safety of the solid battery.

The present disclosure is further described in detail below with reference to specific embodiments, and the embodiments cannot be construed as limiting the scope of protection claimed in the present disclosure.

It is to be noted that, the composite solid electrolyte layer prepared in all Embodiments of the present disclosure and the solid electrolyte layer prepared in Comparative Examples are subjected to the following tests: (1) an electrochemical impedance test is performed by using an electrochemical workstation, with a frequency being 0.1 Hz to 1 MHz; and through the tested electrochemical impedance, the ionic conductivity of the composite solid electrolyte layer and the solid electrolyte layer is calculated according to Formula (I),

$$σ = \frac{d}{Z \times S} , \qquad ( I )$$

where σ is the ionic conductivity (mS/cm), d is the thickness (cm) of the composite solid electrolyte layer and the solid electrolyte layer, Z is the electrochemical impedance (Ω), and S is a cross-sectional area (cm²) of the composite solid electrolyte layer and the solid electrolyte layer; and (2) a tensile strength is tested according to the method in GB/T 1040.3-2006 Determination of Tensile Properties of Plastics.

The average pore diameter of the aramid base film is tested by using a pore diameter instrument meeting the ASTM F316 standard; and the porosity of the aramid base film is calculated according to Formula (II),

$$P = ( 1 - \frac{m}{p \times V} ) \times 100 \% , \qquad ( II )$$

where P is the porosity (%), m is the mass (g) of the aramid base film, ρ is the density (g/cm³) of the aramid base film, and V is the volume (cm³) of the aramid base film.

### Embodiment 1

A method for preparing a composite solid electrolyte layer included the following steps.
(1) Preparation of an aramid base film: 441 g of m-phenylenediamine was dissolved in 5.16 kg of DMAC to obtain a mixed solution, while stirring and in a nitrogen atmosphere, 828 g of isophthaloyl dichloride was added dropwise to the mixed solution for a polymerization reaction, so as to obtain a polymerization reaction system containing meta-aramid; a neutralization treatment was performed on the polymerization reaction system by using 245 g of calcium hydroxide, so as to obtain a neutralization product system; the neutralization product system obtained and PEO with a number-average molecular weight of 8000 were well mixed to obtain an aramid slurry, where a weight percentage of the PEO in the aramid slurry was 10 wt %; the aramid slurry was coated on a polytetrafluoroethylene substrate; after the coating was completed, the substrate was placed in a coagulating bath with a water content of 45% (the coagulating bath consisted of 55 wt % of the DMAC and 45 wt % of water) for a curing treatment, after the curing treatment was completed, the coating layer was stretched in transverse and longitudinal directions, respectively, then washed with water, dried and shaped, and peeled off from the substrate, so as to obtain the aramid base film with a thickness of 15 μm; and the porosity of the aramid base film in this embodiment was measured to be 60%, and an average pore diameter was 200 μm.
(2) Li₆PS₅Cl solid electrolyte powder with an average particle size of 3 μm and adhesive PEO with a weight-average molecular weight of 500000 were placed in a twin screw machine according to a weight ratio of 95:5, and melted for 5 min at 180° C., so as to obtain a solid electrolyte melt. The solid electrolyte melt was extruded and coated on surfaces of two sides of the aramid base film prepared in step (1), so as to obtain a composite solid electrolyte layer precursor with a thickness of 30 μm, where a coating amount of the solid electrolyte melt on the surfaces of the aramid base film was 20 g/m².
(3) When a temperature of the composite solid electrolyte layer precursor was 100° C., a PET release film with a thickness of 20 μm was covered on a surface of a side of the composite solid electrolyte layer precursor away from the aramid base film, so as to obtain a laminated structure.
(4) A first hot rolling treatment was performed on the laminated structure obtained in step (3) for 10 min at 200° C. and 50 MPa, and after the first hot rolling treatment was completed, the PET release film was peeled off to obtain a composite solid electrolyte layer with a thickness of 30 μm.

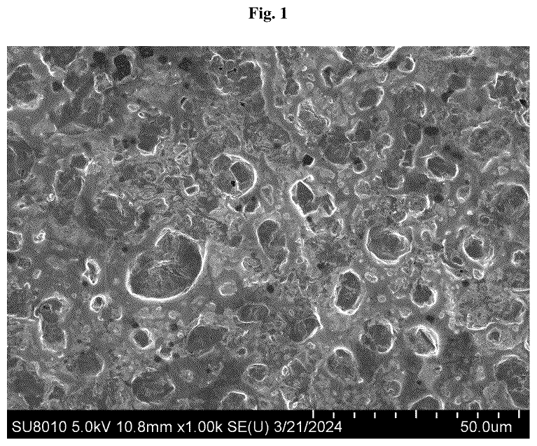

An SEM diagram of the surface of the composite solid electrolyte layer prepared in Embodiment 1 is shown in FIG. 1. From FIG. 1, it can be seen that, under high temperature and pressure, the Li₆PS₅Cl solid electrolyte powder was softened and filled in the aramid base film to form a compact and continuous structure, facilitating the fast transport of lithium ions, and the aramid base film acted as a skeleton and provided mechanical support and flexibility for the composite solid electrolyte layer.

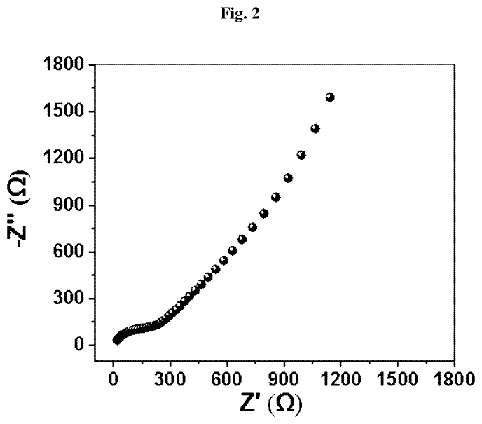

An EIS diagram of the composite solid electrolyte layer prepared in Embodiment 1 is shown in FIG. 2. The impedance of the composite solid electrolyte layer was 2002, and the ionic conductivity of the composite solid electrolyte layer was calculated to be 0.4 mS/cm according to the formula (I).

### Embodiment 2

A method for preparing a composite solid electrolyte layer included the following steps.
(1) Preparation of an aramid base film: 441 g of m-phenylenediamine was dissolved in 5.16 kg of DMAC to obtain a mixed solution, while stirring and in a nitrogen atmosphere, 828 g of isophthaloyl dichloride was added dropwise to the mixed solution for a polymerization reaction, so as to obtain a polymerization reaction system containing meta-aramid; a neutralization treatment was performed on the polymerization reaction system by using 200 g of calcium hydroxide, so as to obtain a neutralization product system; the neutralization product system obtained and 162 g of calcium bicarbonate were well mixed to obtain an aramid slurry; the aramid slurry was coated on a polytetrafluoroethylene substrate; after the coating was completed, a solvent was volatilized for 3 min at 170° C., then the coating layer was stretched in transverse and longitudinal directions, respectively, then water washing was performed at 25° C. to remove the residual solvent, drying and shaping were performed at 100° C., the coating layer was peeled off from the substrate, so as to obtain the aramid base film with a thickness of 20 μm; and the porosity of the aramid base film was measured to be 50% by using a test method same as Embodiment 1, and an average pore diameter was 500 μm.
(2) LATP (Lithium Aluminum Titanium Phosphate) solid electrolyte powder with an average particle size of 10 μm and adhesive PMMA (Poly(methyl methacrylate)) with a weight-average molecular weight of 100000 were placed in a twin screw machine according to a weight ratio of 95:5, and melted for 10 min at 180° C., so as to obtain a solid electrolyte melt; and the solid electrolyte melt was extruded and coated on surfaces of two sides of the aramid base film prepared in step (1), so as to obtain a composite solid electrolyte layer precursor with a thickness of 30 μm, where a coating amount of the solid electrolyte melt on the surfaces of the aramid base film was 30 g/m².
(3) When a temperature of the composite solid electrolyte layer precursor was 150° C., a PET release film with a thickness of 20 μm was covered on a surface of a side of the composite solid electrolyte layer precursor away from the aramid base film, so as to obtain a laminated structure.
(4) A first hot rolling treatment was performed on the laminated structure obtained in step (3) for 10 min at 250° C. and 50 MPa, and after the first hot rolling treatment was completed, the PET release film was peeled off to obtain a composite solid electrolyte layer with a thickness of 35 μm.

### Embodiment 3

A method for preparing a composite solid electrolyte layer included the following steps.
(1) Preparation of an aramid base film: 441 g of m-phenylenediamine was dissolved in 5.16 kg of DMAC to obtain a mixed solution, while stirring and in a nitrogen atmosphere, 828 g of isophthaloyl dichloride was added dropwise to the mixed solution for a polymerization reaction, so as to obtain a polymerization reaction system containing meta aramid; a neutralization treatment was performed on the polymerization reaction system by using 245 g of calcium hydroxide powder, so as to obtain a neutralization product system; the neutralization product system was coated on a polytetrafluoroethylene substrate, where cylindrical protrusions with a diameter of 1 mm and height of 100 μm were arranged on the polytetrafluoroethylene substrate in a two-dimensional tightly-packed manner, thereby the prepared aramid base film had uniformly sized and evenly distributed pores; after the coating was completed, the substrate was placed in a 100° C. vacuum oven for drying for 30 min, the coating layer was peeled off from the substrate after water washing, so as to obtain the aramid base film with a thickness of 15 μm; and the porosity of the aramid base film was measured to be 70%, and an average pore diameter was 850 μm; the aramid base film was a multilayered structure with macropores and micropores, and a volume ratio of the macropores to the micropores was 5:3. It was to be noted that, the macropores in the present disclosure referred to holes with a pore diameter more than 1 μm, and the micropores referred to holes with a pore diameter less than 1 μm.
(2) Li₆PS₅Cl solid electrolyte powder with an average particle size of 5 μm and a mixture (a weight ratio of PEO to LITFSI was 1:0.3) consisting of adhesive PEO with a weight-average molecular weight of 500000 and LITFSI were placed in a twin screw machine according to a weight ratio of 95:5, and melted for 30 min at 100° C., so as to obtain a solid electrolyte melt. The solid electrolyte melt was extruded and coated on surfaces of two sides of the aramid base film prepared in step (1), so as to obtain a composite solid electrolyte layer precursor with a thickness of 30 μm, where a coating amount of the solid electrolyte melt on the surfaces of the aramid base film was 20 g/m².
(3) When a temperature of the composite solid electrolyte layer precursor was 100° C., a PET release film with a thickness of 20 μm was covered on a surface of a side of the composite solid electrolyte layer precursor away from the aramid base film, so as to obtain a laminated structure.
(4) A first hot rolling treatment was performed on the laminated structure obtained in step (3) for 10 min at 50° C. and 50 MPa, and after the first hot rolling treatment was completed, the PET release film was peeled off to obtain a composite solid electrolyte layer with a thickness of 28 μm.

### Embodiment 4

A difference between this embodiment and Embodiment 1 lied in that, in step (2), a melting treatment was performed for 30 min at 80° C. to obtain a solid electrolyte melt, and the remaining steps were the same as Embodiment 1.

### Embodiment 5

A difference between this embodiment and Embodiment 1 lied in that, in step (2), a melting treatment was performed for 1 min at 250° C. to obtain a solid electrolyte melt, and the remaining steps were the same as Embodiment 1.

### Embodiment 6

A difference between this embodiment and Embodiment 1 lied in that, in step (2), a melting treatment was performed for 45 min at 40° C. to obtain a solid electrolyte melt, and the remaining steps were the same as Embodiment 1.

### Embodiment 7

A difference between this embodiment and Embodiment 1 lied in that, in step (1), in the aramid slurry, a weight percentage content of the PEO was 5 wt %, the porosity of the aramid base film prepared accordingly was 50%, an average pore diameter was 20 μm, and the remaining steps were the same as Embodiment 1.

### Embodiment 8

A difference between this embodiment and Embodiment 1 lied in that, in step (1), in the aramid slurry, a weight percentage content of the PEO was 15 wt %, the porosity of the aramid base film prepared in step (1) was 90%, an average pore diameter was 21 μm, and the remaining steps were the same as Embodiment 1.

### Embodiment 9

A difference between this embodiment and Embodiment 1 lied in that, in step (1), the PEO was not added in the aramid slurry, the coagulating bath consisted of 35 wt % of DMAC and 65 wt % of water, the porosity of the aramid base film prepared accordingly was 45%, an average pore diameter was 0.2 μm, and the remaining steps were the same as Embodiment 1.

### Embodiment 10

A difference between this embodiment and Embodiment 1 lied in that, in step (2), the weight ratio of the Li₆PS₅Cl solid electrolyte powder to the adhesive PEO was 99:1, and the remaining steps were the same as Embodiment 1.

### Embodiment 11

A difference between this embodiment and Embodiment 1 lied in that, in step (2), the weight ratio of the Li₆PS₅Cl solid electrolyte powder to the adhesive PEO was 90:10, and the remaining steps were the same as Embodiment 1.

### Embodiment 12

A difference between this embodiment and Embodiment 1 lied in that, in step (4), a temperature for the first hot rolling treatment was 250° C., a pressure was 0.5 MPa, a time was 30 min, and the remaining steps were the same as Embodiment 1.

### Embodiment 13

A difference between this embodiment and Embodiment 1 lied in that, in step (4), a temperature for the first hot rolling treatment was 130° C., a pressure was 25 MPa, a time was 15 min, and the remaining steps were the same as Embodiment 1.

### Embodiment 14

A difference between this embodiment and Embodiment 1 lied in that, in step (4), a temperature for the first hot rolling treatment was 40° C., a pressure was 0.3 MPa, a time was 35 min, and the remaining steps were the same as Embodiment 1.

### Comparative Example 1

A difference between this comparative example and Embodiment 1 lied in that, steps (2) and step (3) were omitted, the Li₆PS₅Cl solid electrolyte powder and the adhesive PEO with a weight-average molecular weight of 500000 were dissolved in acetonitrile according to a weight ratio of 95:5, so as to obtain a slurry with a solid content of 50 wt %, the slurry was coated on surfaces of two sides of the aramid base film prepared in step (1) according to a coating amount of 20 g/m², and dried for 1 h at 50° C., so as to obtain a composite solid electrolyte layer precursor with a thickness of 30 μm; and the remaining steps were the same as Embodiment 1.

### Comparative Example 2

A difference between this comparative example and Embodiment 1 lied in that, step (3) was omitted, a first hot rolling treatment was directly performed on the composite solid electrolyte layer precursor prepared in step (2), and in this comparative example, a release film was not used to protect the composite solid electrolyte layer precursor, leading to adhesion between the composite solid electrolyte layer precursor and a hot-pressing roller, such that a composite solid electrolyte layer could not be obtained through sample preparation.

Test results were shown in Table 1.

TABLE 1

| | | Ionic | Tensile |
|---|---|---|---|
| | Thickness | conductivity | strength |
| | (μm) | (mS/cm) | (MPa) |
| Embodiment 1 | 30 | 0.4000 | 45.0 |
| Embodiment 2 | 35 | 0.0500 | 38.6 |
| Embodiment 3 | 28 | 0.6000 | 48.2 |
| Embodiment 4 | 35 | 0.1000 | 38.5 |
| Embodiment 5 | 40 | 0.0500 | 35.0 |
| Embodiment 6 | 42 | 0.0100 | 32.1 |
| Embodiment 7 | 32 | 0.3000 | 42.0 |
| Embodiment 8 | 28 | 0.4500 | 5.0 |
| Embodiment 9 | 35 | 0.0005 | 40.0 |
| Embodiment 10 | 28 | 0.4200 | 46.0 |
| Embodiment 11 | 35 | 0.0380 | 38.0 |
| Embodiment 12 | 31 | 0.3500 | 45.0 |
| Embodiment 13 | 30 | 0.4200 | 45.0 |
| Embodiment 14 | 44 | 0 | 30.0 |
| Comparative Example 1 | 30 | 0.1500 | 45.0 |
| Comparative Example 2 | / | / | / |

It may be seen from the above description that, in the above embodiments of the present disclosure, the following technical effects are realized.

By comparing Embodiment 1 with Comparative Example 1, it may be seen that, when the same aramid base film and the same hot rolling process were used, the thickness and tensile strength of the composite solid electrolyte layer did not change significantly, and the ionic conductivity in Embodiment 1 was much higher than that in Comparative Example 1, this was because in Embodiment 1, solvents were not introduced when the composite solid electrolyte layer was prepared, such that side reactions between the solid electrolyte and the solvent could be inhibited; and the occurrence of micro-pores formed due to solvent volatilization and uneven distribution can be inhibited, thereby improving the uniformity and compactness of the composite solid electrolyte layer prepared, and improving the ionic conductivity of the composite solid electrolyte layer. Furthermore, compared to Comparative Example 1, the solvents were not introduced in Embodiment 1, such that product costs were reduced, and the generation of waste liquid was reduced while the treatment cost of the waste liquid was reduced.

By comparing Embodiment 1 with Comparative Example 2, it may be seen that, the introducing of the release film could inhibit a direct contact between the composite solid electrolyte layer precursor and the hot-pressing roller in the first hot rolling process, so as to improve processing performance, and at the same time, the adhesion of the composite solid electrolyte layer precursor and the occurrence of pollution phenomena could be reduced, thereby improving the purity and structural integrity of the composite solid electrolyte layer.

By comparing Comparative Examples 1 to 3, it may be seen that, the ionic conductivity in Embodiment 2 was worse than that in Embodiments 1 and 3. This was because a sulfide solid electrolyte was used in Embodiments 1 and 3, and an oxide solid electrolyte was used in Embodiment 2, and the ionic conductivity of the sulfide solid electrolyte itself was higher than that of the oxide solid electrolyte, such that the ionic conductivity in Embodiment 2 was lower than that in Embodiments 1 and 3. Therefore, the method for preparing a composite solid electrolyte layer provided in the present disclosure is suitable for various types of inorganic solid electrolytes.

By comparing Embodiments 1 and 4 to 6, it may be seen that, the temperature for the melting treatment in Embodiment 5 was a maximum value in the preferred range of the present disclosure. According to data in Table 1, it may be seen that, in the temperature, since side reactions between the adhesive and the electrolyte powder started to increase, the ionic conductivity and mechanical strength of the composite solid electrolyte layer started to reduce. The temperature for the melting treatment in Embodiment 6 was too low (an outlier in the preferred range of the present disclosure), leading to incomplete melting of the adhesive and the solid electrolyte powder, consecutive ion transport paths could not be formed, resulting in a reduction in the ionic conductivity. Moreover, since the adhesive was melted incompletely, an adhesive force between the solid electrolytes was insufficient, leading to a reduction in the mechanical strength of the composite solid electrolyte layer. Therefore, compared with other ranges, by limiting the temperature and time of the melting treatment within the above ranges of the present disclosure, the dispersity of the solid electrolyte powder and the adhesive was improved, decomposition side reactions of the adhesive were inhibited, and the adhesive played a better role in achieving an adhesion action, such that the uniformity of the solid electrolyte melt was improved, and the uniformity and compactness of the composite solid electrolyte layer were improved, thereby improving the mechanical strength and ionic conductivity of the composite solid electrolyte layer.

By comparing Embodiments 1 and 7 to 9, it may be seen that, since the porosity of the aramid base film was high in Embodiment 8, the ionic conductivity was improved accordingly. However, as the porosity increased, the structure stability of the aramid base film reduced, leading to a great reduction in the mechanical strength of the composite solid electrolyte. The porosity of the aramid base film was low in Embodiment 9, and the average pore diameter was small (which was the outlier in the preferred range of the present disclosure), such that a transport route of ions was limited, resulting in reduction in the ionic conductivity. Therefore, compared with other ranges, by limiting the porosity and average pore diameter of the aramid base film within the above ranges of the present disclosure, more filling spaces were provided for the solid electrolyte material, such that the solid electrolyte material was fully filled in pores of the aramid base film, and more channels were provided for the transport of lithium ions, thereby improving the flexibility, mechanical strength, and ionic conductivity of the composite solid electrolyte layer. Furthermore, the reduction in the mechanical strength due to excessive filling of the solid electrolyte material was also inhibited.

By comparing Embodiments 1, 10 and 11, it may be seen that, since the amount of the adhesive added in Embodiment 11 was excessive (an outlier in the preferred range of the present disclosure), the thickness increased, and the tensile strength reduced. Furthermore, excessive adhesive occupied a filling space of the inorganic solid electrolyte, such that the ionic conductivity was reduced. Therefore, compared with other ranges, by limiting the weight ratio of the solid electrolyte powder to the adhesive within the above range of the present disclosure, in an aspect, the utilization of the solid electrolyte powder and the adhesive was improved, and the processability of the solid electrolyte powder was improved; and in another aspect, a volume and interface of the composite solid electrolyte layer occupied by excessive adhesive was reduced, such that the mechanical strength, and ionic conductivity of the composite solid electrolyte layer were improved.

By comparing Embodiments 1 and 12 to 14, it may be seen that, since the temperature and pressure of the hot rolling treatment in Embodiment 14 were low (which were the outlier in the preferred range of the present disclosure), the adhesion of the interfaces of the composite solid electrolyte layer was insufficient, forming gaps and defects, such that resistance to ion migration increased, thereby reducing the conductivity. Therefore, compared with other ranges, by limiting the temperature, pressure, and time of the first hot rolling treatment within the above range of the present disclosure, the solid electrolyte material was softened, the interfacial binding force between the layers in the first laminated structure was increased, the compaction density of the composite solid electrolyte layer was increased, and the interfacial impedance was reduced, thereby improving the ionic conductivity and structure stability of the composite solid electrolyte layer.

It is to be noted that terms “first”, “second” and the like in the description and claims of the present disclosure are used for distinguishing similar objects rather than describing a specific sequence or a precedence order. It should be noted that the terms used in such a way may be exchanged where appropriate, in order that the implementations of the present disclosure described here can be implemented in an order other than those described herein.

The above are only the preferred embodiments of the present disclosure and are not intended to limit the present disclosure. For those skilled in the art, the present disclosure may have various modifications and variations. Any modifications, equivalent replacements, improvements and the like made within the spirit and principle of the present disclosure all fall within the scope of protection of the present disclosure.

1. A method for preparing a composite solid electrolyte layer, comprising:
step S1, coating a solid electrolyte raw material on two side surfaces of an aramid base film, so as to obtain a composite solid electrolyte layer precursor;
step S2, covering a release film on at least one side surface of the composite solid electrolyte layer precursor, so as to obtain a first-laminated structure; and
step S3, performing a first hot rolling treatment on the West-laminated structure, and then peeling off the release film to obtain the composite solid electrolyte layer.

2. The method for preparing a composite solid electrolyte layer according to claim 1, wherein the solid electrolyte raw material in the step S1 does not contain a liquid.

3. The method for preparing a composite solid electrolyte layer according to claim 1, wherein the solid electrolyte raw material in the step S1 does not contain a solvent.

4. The method for preparing a composite solid electrolyte layer according to claim 3, wherein the step S1 further comprising: performing a melting treatment on the solid electrolyte raw material to obtain a solid electrolyte melt, and coating the solid electrolyte melt on the two side surfaces of the aramid base film, so as to obtain the composite solid electrolyte layer precursor.

5. The method for preparing a composite solid electrolyte layer according to claim 4, wherein a coating amount of the solid electrolyte melt on the surface of the aramid base film is 20 g/m² to 60 g/m².

6. The method for preparing a composite solid electrolyte layer according to claim 4, wherein a temperature for the melting treatment is 80° C. to 250° C., and a time is 1 min to 30 min.

7. The method for preparing a composite solid electrolyte layer according to claim 1, wherein the solid electrolyte raw material comprises a solid electrolyte powder and an adhesive.

8. The method for preparing a composite solid electrolyte layer according to claim 7, wherein an average particle size of the solid electrolyte powder is 0.1 μm to 10 μm.

9. The method for preparing a composite solid electrolyte layer according to claim 7, wherein a weight ratio of the solid electrolyte powder to the adhesive is (95-99): (1-5).

10. The method for preparing a composite solid electrolyte layer according to claim 7, wherein the solid electrolyte powder is an inorganic solid electrolyte powder.

11. The method for preparing a composite solid electrolyte layer according to claim 10, wherein the inorganic solid electrolyte powder is selected from one or more of a group consisting of an oxide solid electrolyte, a sulfide solid electrolyte, and a halide solid electrolyte.

12. The method for preparing a composite solid electrolyte layer according to claim 1, wherein the release film is a solid film without pores.

13. The method for preparing a composite solid electrolyte layer according to claim 1, wherein a thickness of the release film is 10 μm to 50 μm.

14. The method for preparing a composite solid electrolyte layer according to claim 1, wherein a material of the release film is a first organic polymer material, and the first organic polymer material is selected from one or more of a group consisting of polyimide, polyethylene terephthalate, polyether ether ketone, poly(p-phenylene sulfide), and poly(p-phenylene benzobisoxazole).

15. The method for preparing a composite solid electrolyte layer according to claim 1, wherein the aramid base film is a porous film; and the porosity of the aramid base film is 50% to 90%.

16. The method for preparing a composite solid electrolyte layer according to claim 1, wherein an average pore diameter of the aramid base film is 0.1 μm to 2000 μm, and/or an average thickness of the aramid film is 3 μm to 25 μm.

17. (canceled)

18. The method for preparing a composite solid electrolyte layer according to claim 1, wherein a thickness of the composite solid electrolyte layer precursor is 5 μm to 50 μm.

19. The method for preparing a composite solid electrolyte layer according to claim 1, wherein the step S2 further comprising: when a temperature of the composite solid electrolyte layer precursor is 50° C. to 250° C., covering the release film on at least one side surface of the composite solid electrolyte layer precursor, so as to obtain the first-laminated structure.

20. The method for preparing a composite solid electrolyte layer according to claim 1, wherein in the step S3, a temperature for the first hot rolling treatment is 50° C. to 250° C., and/or a pressure of the first hot rolling treatment is 0.5 MPa to 50 MPa.

21. (canceled)

22. The method for preparing a composite solid electrolyte layer according to claim 1, wherein a time for the first hot rolling treatment is 1 min to 30 min.

23. (canceled)
